(19) United States
(12) Patent Application Publication
(10) Pub. No.: US 2007/0289462 A1
(43) Pub. Date: Dec. 20, 2007

(54) Turner assembly for a web-fed rotary press

(75) Inventors: Markus Botsch, Mertingen (DE); Stefan Menzinger, Dasing-Wessiszell (DE); Erich Wagner, Augsburg (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG

(21) Appl. No.: 11/807,813

(22) Filed: May 30, 2007

(30) Foreign Application Priority Data
May 31, 2006 (DE) 10 2006 025 758.8

(51) Int. Cl. B41F 13/54

(52) U.S. Cl. 101/227

(57) ABSTRACT

A turner assembly for a web-fed rotary press includes a plurality of turner bars, wherein at least one web of a web-like printed material is introduced into the turner assembly in an entry direction. Slitters arranged upstream of the turner bars in the entry direction of the printed material cut the web into partial webs which are turned and deflected on the turner bars such that turned partial webs are led out of the turner assembly in an exit direction. At least one turner bar is assigned to each partial web and is individually moved in the entry direction such that each of the partial webs are fed to one of several formers or folder superstructures, depending on the position of the corresponding turner bar or each corresponding turner bar.

### BACKGROUND OF THE INVENTION

1. Field of the Invention

The invention concerns a turner assembly for a web-fed rotary press configured to receive a web of a web-like printed material in an entry direction, the turner assembly having a plurality of turner bars and slitters arranged upstream of the turner bars in the entry direction of the printed material, the slitters being configured to cut the web into partial webs, and the partial webs can be turned and deflected on the turner bars such that turned partial webs are led out of the turner assembly in an exit direction.

2. Description of the Related Art

A turner assembly of a web-fed rotary press receives a web of a web-like printed material, which is usually fed to the turner assembly in several planes arranged one above the other, and which is separated into partial webs and then turned and deflected on the turner assembly. During a turning and deflection by about 90° relative to an axis of the turner assembly, turned partial webs leave the turner assembly in an exit direction that runs perpendicularly to an entry direction of the uncut webs of the web-like printed material or the unturned partial webs into the turner assembly. It is also possible for partial webs to be turned and deflected in a turner assembly such that the exit direction of the partial webs out of the turner assembly is the same as the entry direction of the partial webs into the turner assembly.

In previously known practical turner assemblies, especially after turning and deflection of a partial web by 90° relative to the axis of the turner assembly, the turned partial web is fed in the exit direction only to one and the same former of a folder superstructure. As a result of this limited flexibility of previously known practical turner assemblies, after a partial web has been turned and deflected and it is to be selectively fed to one of several folder superstructures or formers, several turner assemblies are required. Therefore, a separate turner assembly must be provided for each folder superstructure and former. This is complicated and expensive.

### SUMMARY OF THE INVENTION

An object of the present invention is to create a novel turner assembly for a web-fed rotary press. The object is met by a turner assembly for a web-fed rotary press configured to receive a web of a web-like printed material in an entry direction, the turner assembly having a plurality of turner bars and slitters arranged upstream of the turner bars in the entry direction of the printed material, the slitters being configured to cut the web into partial webs, and the partial webs can be turned and deflected on the turner bars such that turned partial webs are led out of the turner assembly in an exit direction. In accordance with the present invention, one turner bar is assigned to each partial web of the web-like printed material, such that the turner bar or each turner bar assigned to each of the partial webs is individually moved in the entry direction such that each of the partial webs are selectively fed to one of several formers or folder superstructures, depending on the position of the corresponding turner bar or each corresponding turner bar.

The turner assembly of the present invention is distinguished by a high degree of flexibility. For example, after being turned and deflected, a partial web may be selectively fed to one of several folder superstructures or formers with the turner assembly of the invention. To this end, at least one turner bar, which can be moved in the entry direction, is assigned to each partial web. Depending on the position of the corresponding turner bars in relation to the respective partial webs, the latter are selectively fed to one of several formers or folder superstructures. This flexibility is present both when the exit direction is displaced about 90° relative to the entry direction of the partial webs and when the exit direction of the partial webs is the same as the entry direction. Each partial web can be individually turned and deflected independently of other partial webs and then selectively fed to one of several folder superstructures or formers.

The turner assembly of the present invention thus provides full flexibility and mixability of the partial webs to be turned on the turner assembly with respect to folder superstructures or formers, to which the partial webs turned and deflected on the turner assembly are fed. This allows a reduction in the required number of turner assemblies compared to the prior art and thus reduces investment costs for web-fed rotary presses.

Preferably, at least one turner bar, which can be individually moved in the entry direction, is present for each of at least three partial webs in order to feed each of the partial webs to one of at least three different formers or folder superstructures, either in an exit direction displaced about 90° relative to the entry direction or in an exit direction that is the same as the entry direction, depending on the position of the corresponding turner bars. In this connection, either each of the partial webs can be fed to its own former or folder superstructure or at least some of the partial webs can be fed to a common former or folder superstructure.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a top view of a turner assembly of the invention for a web-fed rotary press in a first state or first position of the turner bars;

FIG. 2 is a top view of the turner assembly of FIG. 1 in a second state or second position of the turner bars;

FIG. 3 is a top view of the turner assembly of FIG. 1 in a third state or third position of the turner bars;

FIG. 4 is a top view of the turner assembly of FIG. 1 in a fourth state or fourth position of the turner bars;

FIG. 5 is a top view of the turner assembly of FIG. 1 in a fifth state or fifth position of the turner bars;

FIG. 6 is the top view of the turner assembly of FIG. 1 in a sixth state or sixth position of the turner bars; and

FIG. 7 is the top view of the turner assembly of FIG. 1 in another state or another position of the turner bars.

### DETAILED DESCRIPTION OF THE PRESENTLY PREFERRED EMBODIMENTS

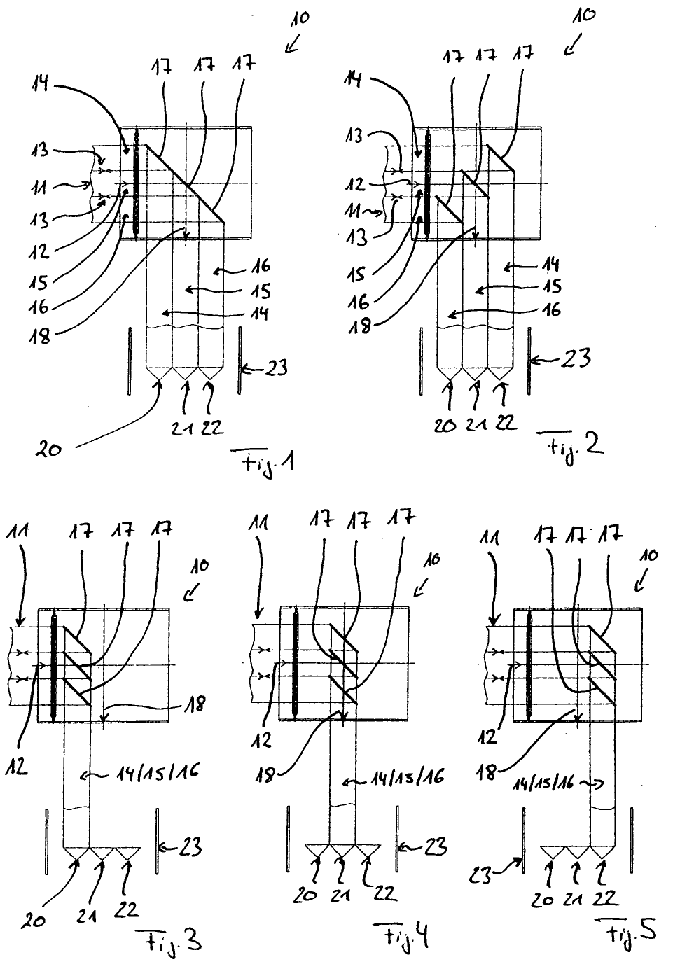

The present invention will now be described with reference to FIGS. 1 to 7, which illustrate an example of a turner assembly 10, to which a web 11 of a web-like printed material can be fed in an entry direction 12. In the specific embodiment shown here, the web 11 can be cut into three partial webs 14, 15, and 16 by two schematically indicated slitters 13, and the partial webs 14, 15, and 16 can be turned and deflected on turner bars 17 of the turner assembly 10. In FIGS. 1 to 5, the exit direction 18 of the partial webs 14 to 16 from the turner assembly 10 is displaced by 90° relative to the entry direction 12, i.e., the exit direction is approximately perpendicular to the entry direction. In FIGS. 6 and 7, on the other hand, the exit direction 19 is the same as the entry direction 12.

In accordance with the present invention, at least one turner bar 17 is assigned to each partial web 14, 15, and 16. Each of the turner bars 17 can be individually moved in the entry direction 12 and thus independently of the other turner bars 17. This is apparent from a comparison of FIGS. 1 to 5, which show the turner bars 17, which are assigned to the partial webs 14, 15, and 16, in different relative positions with respect to the entry direction 12 of the turner assembly 10. In the positions of the turner bars 17 shown in FIGS. 1 and 2, each of the partial webs 14, 15, and 16 turned and deflected on the same turner bars 17 is fed to its own individual former 20, 21, or 22 of a folder superstructure 23. In the position of the turner bars 17 shown in FIG. 1, partial web 14 is fed to former 20, partial web 15 to former 21, and partial web 16 to former 22. In the position of the turner bars 17 shown in FIG. 2, on the other hand, partial web 14 is fed to former 22, partial web 15 to former 21, and partial web 16 to former 20 of the folder superstructure 23. Accordingly, each of the turned and deflected partial webs 14, 15, and 16 is fed to its own former 20, 21, or 22 in the positions of the turner bars 17 shown in FIGS. 1 and 2.

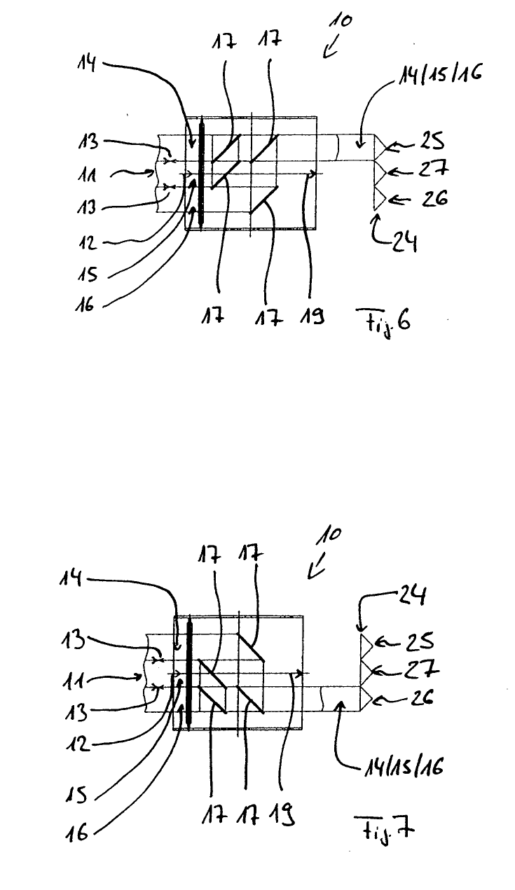

FIGS. 3 to 5, on the other hand, show positions of the turner bars 17 in which all three turned and deflected partial webs 14, 15, and 16 are fed to a common former of the folder superstructure 23. For example, in the position of the turner bars 17 shown in FIG. 3, all three partial webs 14, 15, and 16 are fed to former 20 of the folder superstructure 23. In FIG. 4, the partial webs 14, 15, and 16 are fed to former 21 of the folder superstructure 23, and in FIG. 5, they are fed to former 22 of the folder superstructure 23. To which common former 20, 21, or 22 the partial webs 14, 15, and 16 are fed according to FIGS. 3 to 5 thus depends on the position of the turner bar 17 with respect to the entry direction 12 of the turner assembly 10.

Although not shown in FIGS. 1 to 5, it is also possible for two of the three partial webs 14, 15, and 16 to be fed to a common former, and for the remaining partial web to be fed to its own, separate former. This can be adjusted by moving the turner bars 17 in the entry direction 12 of the turner assembly 10.

Accordingly, in the drawings of the turner assembly 10 of FIGS. 1 to 5, each of the partial webs 14, 15, and 16 can be turned and deflected on the same assigned turner bar 17, so that the exit direction 18 of the partial webs 14, 15, and 16 out of the turner assembly 10 is displaced by about 90° relative to the entry direction 12 of the partial webs into the turner assembly 10. Depending on the position of the turner bars 17 with respect to the entry direction 12 of the turner assembly 10, each of the partial webs 14, 15, and 16 can be fed to a former 20, 21, or 22, such that the position of the turner bars 17 predetermines to which of the formers 20 to 22 each of the partial webs 14 to 15 is fed. Due to the fact that each turner bar 17 can be moved individually and thus independently of the other turner bars 17 with respect to the entry direction 12 of the turner assembly 10, full flexibility and mixability are obtained with respect to the feeding of the partial webs 14, 15, and 16 into the formers 20, 21, and 22 of the folder superstructure 23.

Although FIGS. 1 to 5 show only one turner bar 17 for each of the partial webs 14, 15, and 16, several turner bars 17 are preferably assigned to each partial web 14, 15, and 16. For example, each partial web 14, 15, and 16 can be assigned two turner bars 17, which can be individually moved in the entry direction 12 of the turner assembly 10 independently of the other turner bars, such that, in the illustrations of FIGS. 1 to 5, only one turner bar 17 per partial web 14, 15, and 16 is involved in the turning and deflection of the associated partial web, while the other turner bars 17 are moved into standby positions, which are not shown in the drawings.

In FIGS. 6 and 7, a total of four turners bars 17 are involved in the turning and deflection of the partial webs 14, 15, and 16. In this connection, two of the turner bars 17 are assigned to one of the partial webs, and one turner bar is assigned to each of the other two partial webs. In the specific embodiment illustrated in FIG. 6, two of the turner bars 17 for turning and deflecting the partial webs 14, 15, and 16 are involved in turning and deflecting partial web 14, while in the specific embodiment illustrated in FIG. 7, two of the turner bars 17 are involved in turning and deflecting partial web 16. Turner bars that are not involved in turning and deflecting the partial webs are moved into standby positions, which are not shown in the drawings.

In FIGS. 6 and 7, all of the turner bars 17 are moved into a position in which the turned partial webs 14, 15, and 16 are led out of the turner assembly 10 in an exit direction 19 that is the same as the entry direction 12 of the turner assembly 10. In this regard, as shown in FIGS. 6 and 7, all of the partial webs 14, 15, and 16 can be fed to a common former of a folder superstructure 24, namely, to a former 25 in FIG. 6 and a former 26 in FIG. 7. Although not shown in FIGS. 6 and 7, the partial webs 14, 15, and 16 can also be fed to the common former 27 of the folder superstructure 24. It is also possible, in the case of turning in which the exit direction is the same as the entry direction, to feed turned and deflected partial webs to separate formers.

The invention is not limited to turner assemblies for three partial webs of each web of printed material to be cut, but rather it can also be used in turner assemblies in which a web of printed material is cut into two, four, or even more partial webs, such that each partial web is then assigned at least one turner bar that can be moved in the entry direction individually and thus independently of the other turner bars. In this case, the number of formers again corresponds to the number of partial webs, so that full flexibility and mixability is again present for turned and deflected partial webs with respect to the formers to which the turned partial webs can be fed.

Each of the turner bars 17 of the turner assembly 10 of the invention can not only be individually moved linearly in the entry direction 12 of the turner assembly but rather can also be swiveled individually and thus independently of the other turner bars 17 in order to change its orientation with respect to the partial web to which it is assigned. For example, FIGS. 6 and 7 show the different orientations of the turner bars 17 relative to the partial webs 14, 15, and 16, into which the turner bars 17 can be transferred by the swiveling movement.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A turner assembly of a web-fed rotary press for receiving a web of a web-like printed material in an entry direction, comprising a plurality of turner bars, and slitters arranged upstream of the plurality of turner bars in the entry direction, said slitters being configured to cut the web into partial webs, at least one of said plurality of turner bars being assigned to each of the partial webs and configured to turn and deflect the partial webs so that the partial webs are led out of the turner assembly in an exit direction to one of a plurality of formers, each of said turner bars being individually movable in the entry direction such that each of the partial webs is selectively fed to any of the plurality of formers based on a position of said at least one of the plurality of turner bars assigned to the each of the each of the partial webs.

2. The turner assembly of claim 1, wherein said at least one of the plurality of turner bars assigned to the each of the each of the partial webs is individually movable in the entry direction such that one of each of the partial webs is fed to a respective former or at least some of the partial webs are fed to a common one of the formers.

3. The turner assembly of claim 1, wherein each of the partial webs is turned and deflected on said at least one of the plurality of turner bars assigned to the each of the each of the partial webs such that the exit direction is displaced by about 90° relative to the entry direction.

4. The turner assembly of claim 1, wherein said slitters are configured to cut the web into at least three partial webs, wherein at least one of said plurality of turner bars is assigned for each of the at least three partial webs and configured to feed each of the partial webs to one of at least three different formers in an exit direction displaced about 90° relative to the entry direction, depending on the position of said at least one of said plurality of turner bars.

5. The turner assembly of claim 1, wherein said plurality of turner bars are configured so that the each of the partial webs are turned and deflected on said at least one of the plurality of turner bars assigned to the each of the each of the partial webs such that the exit direction is the same as the entry direction.

6. The turner assembly of claim 1, wherein said slitters are configured to cut the web into at least three partial webs, wherein at least one of said plurality of turner bars is assigned for each of the at least three partial webs and configured to feed each of the partial webs to one of at least three different formers in an exit direction that is the same as the entry direction, depending on the position of said at least one of said plurality of turner bars

7. The turner assembly of claim 1, wherein the number of formers cooperating with said turner assembly corresponds to the number of partial webs.
